(19) United States
(12) Patent Application Publication
(10) Pub. No.: US 2004/0122917 A1
(43) Pub. Date: Jun. 24, 2004

(54) Distributed storage system for data-sharing among client computers running defferent operating system types

(76) Inventors: Jaishankar Moothedath Menon, San Jose, CA (US); David Allan Pease, Reedwood, CA (US); Robert Michael Rees, Los Gatos, CA (US)

Correspondence Address: KHANH Q. TRAN, IBM CORPORATION, INTELLECTUAL PROPERTY LAW, DEPT. C4TA/J2B, 650 HARRY ROAD, San Jose, CA, 95120-6099, US

(21) Appl. No.: 10/323,113

(22) Filed: Dec. 18, 2002

(51) Int. Cl. G06F 15/16

(52) U.S. Cl. 709/219

(57) ABSTRACT

A distributed data storage system for sharing data among client computers running different types of operating systems by separating metadata from data. Data is stored in storage pools that are accessed by the client computers through a storage network. Metadata is stored in a metadata store and provided to the client computers by a cluster of metadata servers. The client computers communicate with the metadata servers using a Storage Tank protocol and over a control network. Each client computer runs an operating system-specific client program that provides the client side functions of the Storage Tank protocol. The client program preferably includes a file system interface for communicating with the file system in the storage system and user applications, a client state manager for providing data consistency, and a plurality of operating system services for communicating with the metadata servers.

### TECHNICAL FIELD

This invention relates to computer storage systems, and more particularly to a storage system capable of sharing data with multiple client computers that run different types of operating systems such as AIX, Linux and Windows.

### BACKGROUND OF THE INVENTION

Today's information systems typically support client computers that run on different operating systems such as Windows, Linux, Solaris, and AIX. A useful information system must allow these computers to easily share data despite their different software bases. Accordingly, the associated data storage system must include appropriate support functions to permit the different computers, possibly running different operating systems, to share data. As an example, a desirable storage system must allow various computers running AIX, Linux and Windows operating systems to access and share data. A file created by one computer can be found and read by other computers, whether they run the same or a different operating system than the one on the creating computer.

Current storage systems that allow files to be shared among heterogeneous computers work as follows. A server, typically called a file server, is interposed between the computers trying to share files, and the data stored on disks. The computers that want to share files run software called the file system client. File system clients communicate with the file server using a well-defined network file protocol such as the Network File System (NFS). When a file is created by a computer, it is written through the file server to the disks. When that file is read by the same or by another computer, the data is read from the disks, flows through the file server, and is then delivered to the computer that wants to read that file. FIG. 1 illustrates such a prior art storage system that supports data-sharing among the heterogeneous client computers using a file sever. The client computers 101, 102 and 103 each runs a different operating system. A file server 105 is provided between the client computers 101-103 and shared disks 106. The heterogeneous clients 101-103 communicate with the file server 105 using standard network protocols such as the Network File System (NFS), Andrew File System (AFS), Common Internet File System (CIFS), etc.

Files are organized on the file server in a tree or hierarchy. An example of a file hierarchy is shown in FIG. 2. The hierarchy includes directories and files. The files are the leaf nodes in the tree. There are 3 files in the hierarchy shown in FIG. 2. These files are part of the directory/almaden/storage. That directory is, in turn, part of the /almaden directory, and so on.

In addition to being able to read and write files, computers can get information about the files and directories by issuing various other commands to the file server. Information about files and directories is called metadata. For example, a READDIR command can be issued to list all the contents of a directory. A READDIR command issued against /almaden/storage would list the 3 files in that directory. A STAT command can be issued against a file to get information about the file such as when it was created and how large the file is.

In order to be able to respond to commands such as READDIR and STAT, the file server keeps metadata information on its disks. Metadata is usually much smaller than the data itself. For example, a file server might need to keep 500 bytes of metadata information per file. The average size of a file may be 16 K bytes. Thus, the size of the metadata is 1/32 of the size of the data, in the example above. Generally, the size of metadata varies between 1 and 10% of the size of the data, depending upon the specifics of the data being stored.

When a file is being written by a computer, other computers are not allowed to write to the same file at the same time. The computer that is writing gets a lock on the file called a write lock. Write lock information is maintained in the file server. By obtaining the write lock, the file server can prevent other computers from writing simultaneously to the same file.

Prior art storage systems for sharing data among computers of different operating systems suffer several drawbacks. The addition of an extra file server in the data path increases the data access time and in turn, the user response time. Also, since multiple servers are usually required for handling the large amount of data of today's customers, the computers need to know which of the file servers has the required data. In addition, there is no easy way to balance the load across the multiple file servers. When a file server fails, it also loses information about the write locks that it was holding on behalf of one or more computers. This can cause a file to become corrupted. Finally, whenever a file server must be replaced with another produced by a different manufacturer, all data must be copied from the old file server to the new file server, before the new file server becomes operational.

Therefore, there remains a need for a storage system that allows efficient data sharing among client computers running different operating systems without the drawbacks of the prior art systems described above.

### SUMMARY OF THE INVENTION

It is an object of the present invention to provide a distributed storage system and method for sharing data among client computers running different types of operating systems.

It is another object of the invention to provide a distributed storage system that maintains data and metadata in separate servers and stores to remove a potential data-transfer bottleneck in the data path.

It is yet another object of the invention to provide a distributed storage system in which the client computers access data via a storage network and access metadata via a control network.

It is still another object of the invention to provide a Storage Tank (™) protocol for the client computers to communicate with the servers in the distributed storage system such that a file system of the storage system would appear as a local file system to the client computers.

It is a further object of the invention to provide a client program in each client computer that provides client-end functions to support the Storage Tank (™) protocol.

To achieve these and other objects, the invention provides a distributed storage system that supports data sharing among heterogeneous client computers based on two logical networks for data transfer. A storage network to which shared storage pools are attached and through which the client computers can access data in the storage pools. The second network is a control network through which the client computers could obtain metadata without degrading the performance of the data path. The client computers communicate with one or more metadata servers for metadata operations. The metadata servers are preferably clustered to form a metadata server cluster for load-balancing and fail-over processing purposes. The control network is preferably implemented on a customer's existing IP network.

The client computers communicate with the metadata servers over the control network using the Storage Tank (™) protocol. On each client computer, the distributed storage system of the invention provides a client program that includes functions to support the Storage Tank (™) protocol. The client program includes a file system interface, a client state manager, and operating system (OS) services. The file system interface allows the client program to communicate with the applications of the client computer. The client state manager is an intermediary between the platform-specific file system and the metadata servers. It maintains all data access locks owned by the client computer. The OS services are functions specific to the client's operating system that must be adopted in porting to a new operating system.

The Storage Tank (™) protocol allows the client programs to obtain metadata such as directory and file information from the metadata servers. Using this protocol, the client programs can also acquire and maintain access locks so that data-sharing among the clients is always consistent and reliable. In case of a server failure, the client programs might reassert the locks they hold to a new server through the Storage Tank (™) protocol. If a metadata server is replaced with a new type of server, the storage system requires only the metadata to be moved to the new metadata server, thus avoiding the penalty of having to move the data itself.

Additional objects and advantages of the present invention will be set forth in the description which follows, and in part will be obvious from the description and the accompanying drawing, or may be learned from the practice of this invention.

### BRIEF DESCRIPTION OF THE DRAWING

FIG. 1 is a block diagram of a prior art storage system that provides data sharing among heterogeneous client computers using a file sever.

FIG. 2 illustrates an example file hierarchy in a prior art file server.

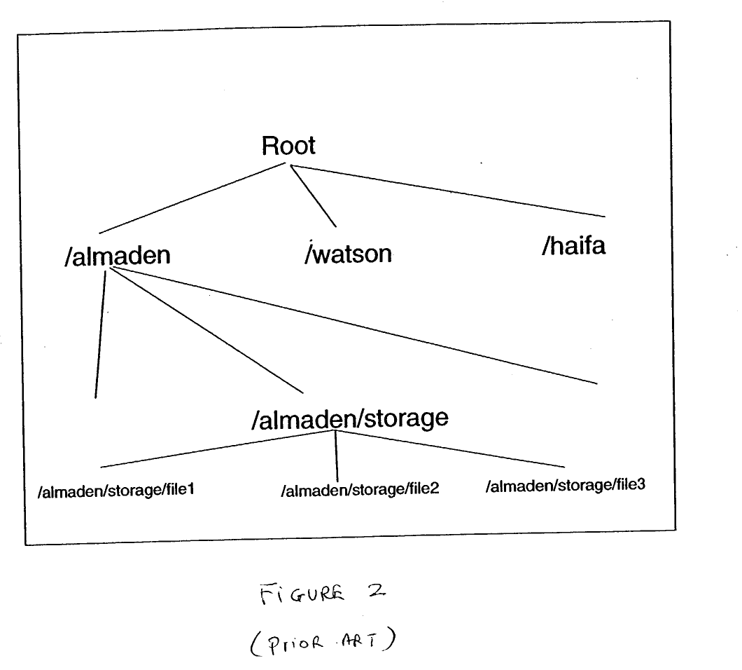

FIG. 3 is a block diagram showing the components of the distributed storage system in accordance with the invention.

FIG. 4 is a block diagram showing a preferred embodiment of the client program to support in accordance with the invention.

FIG. 5 is a flow chart showing a preferred process for the client program to reassert data access locks to a new metadata server in case of a server failure.

FIG. 6 is a flow chart showing a preferred process for moving metadata from a failed metadata server to a new metadata server in accordance with the invention.

### DESCRIPTION OF THE PREFERRED EMBODIMENTS

The invention will be described primarily as a distributed storage system and method for providing data sharing among heterogeneous client computers using separated data and metadata servers. However, persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program means for executing the operations of the invention.

Also, an article of manufacture, such as a pre-recorded disk or other similar computer program product, for use with a data processing system, could include a storage medium and program means recorded thereon for directing the data processing system to facilitate the practice of the method of the invention. Such apparatus and articles of manufacture also fall within the spirit and scope of the invention.

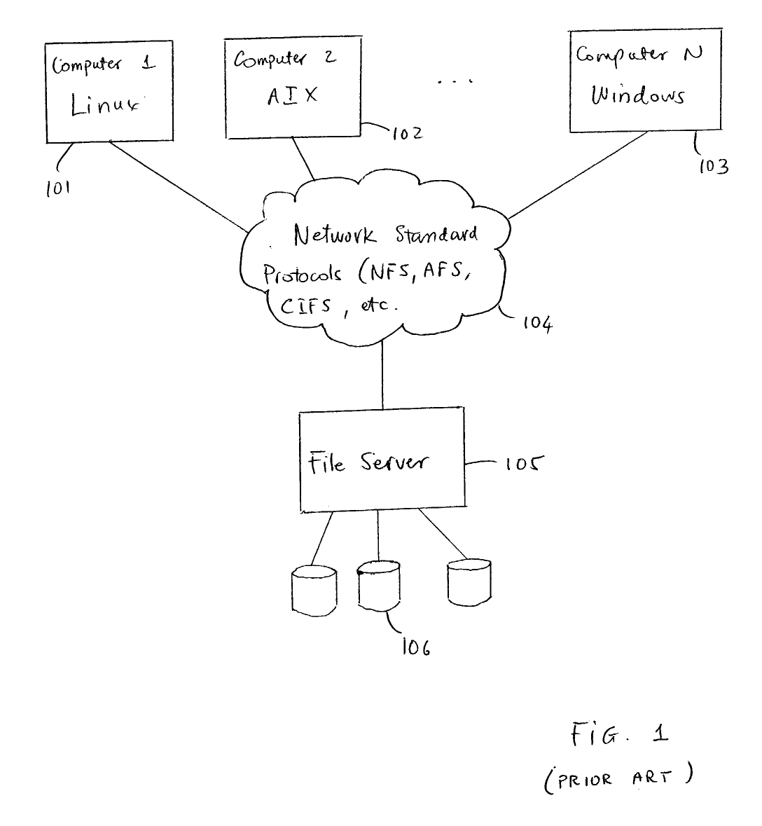

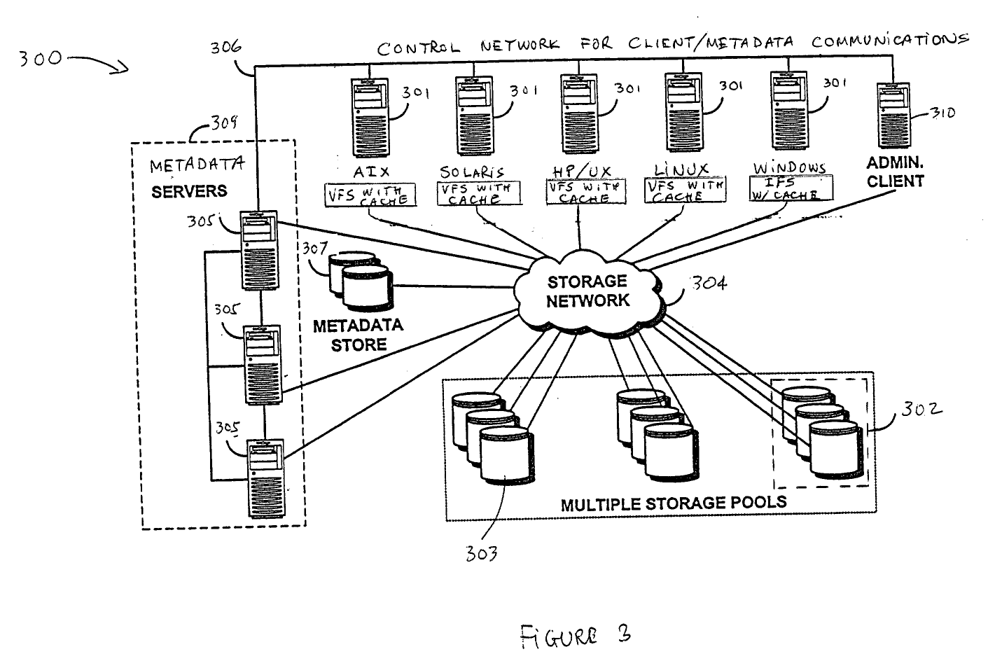

FIG. 3 is a block diagram of a distributed storage system 300 in accordance with the invention. Client computers 301 could access and share data in one or more storage pools 302. Each storage pool 302 consists of shared storage devices, such as storage disks 303. For illustration purposes, the client computers 301 are shown with five different operating systems: AIX, Solaris, HP/UX, Linux, and Windows 2000/XP. In addition, a client computer 310 is typically used for managing and monitoring the performance of the distributed storage system 300. Although FIG. 1 shows only five client computers 301, the storage system 300 of the invention may support thousands of such clients 301 running these five operating systems. The client computers 301 are connected to the shared storage devices 303 through a storage network 304, and to a group of metadata servers 305 via a control network 306. Metadata is kept in the metadata store 307. The storage network 304 might be one of the existing storage area networks (SANs).

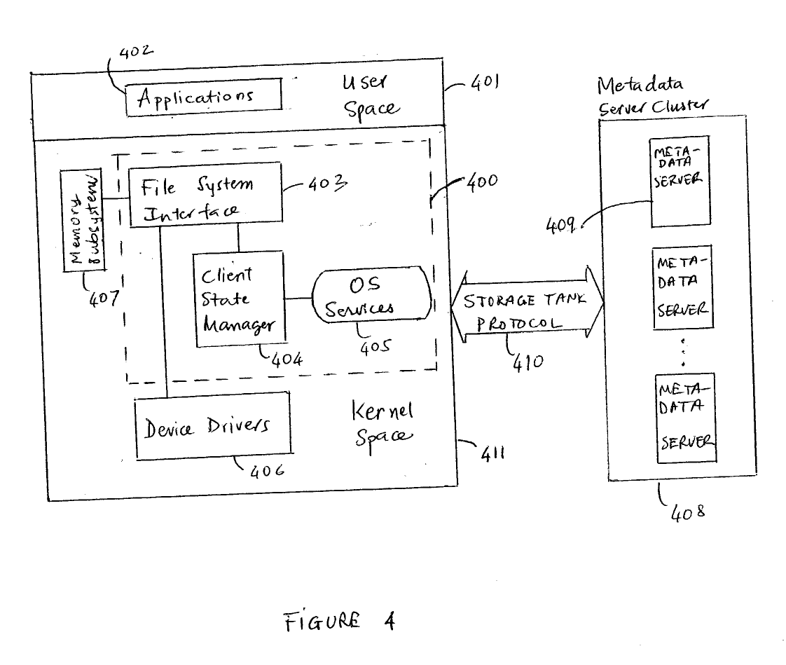

Each client computer 301 runs a piece of software called a client program (not shown) that will be described in detail below in reference to FIG. 4. The client program communicates with a file system interface for the respective operating system running on that client computer. For example, the client program communicates with a Virtual File System (VFS) interface on Unix-based computer systems and with an Installable File System (IFS) interface on Windows-based computer systems. Similar file interfaces might be used for client computers running other operating systems. In FIG. 3, the file system interfaces for the client computers 301 are shown as VFS for the AIX, Solaris, HP/UX and Linux operating systems, and as IFS for the Windows operating system.

The metadata servers 305 are clustered together to form a metadata server cluster 309 on the left side of FIG. 3. With such a configuration, the storage devices and systems that maintain the user data are separated from those that handle the user metadata.

The storage system 300 of the invention thus comprises two logical networks: a control network 306 and a storage network 304. The control network 306 is used by file system clients 301 to communicate with the metadata servers 305. The control network 306 carries only messages and metadata, so the amount of data transferred over it is minimal. In the preferred embodiment of the invention, the control network 306 is implemented over a customer's existing TCP/IP network using the Storage Tank (™) protocol that is described in detail below in reference to FIGS. 4-6.

The second network of the storage system 300 is the storage network 304, also referred to as a Storage Area Network (SAN). The client computers 301, metadata servers 305, and shared storage devices 303 are all connected to the high-speed storage network 304. The storage network 304 is used for all data transfer between the storage devices 303 of the data store 302 and the client computers 301. By removing the metadata servers 305 from the data path, the storage system 300 of the invention eliminates performance overhead and potential bottlenecks that exist in current shared-data storage systems.

An Installable File System (IFS) for a Windows-based client computer, or a Virtual File System (VFS) in the case of a Unix client computer, is installed on each of the client computers 301. An IFS or VFS directs requests for metadata and write locks to one of the metadata servers 305 while sending requests for data to shared storage devices 303 on the storage network 304. The client computers 301 can access data directly from any storage device attached to the storage network 304. They can aggressively cache file data, as well as metadata and locks that they obtain from a metadata server 301, in memory.

The storage system 300 of the invention might support multiple store pools 302 for its file data and multiple metadata servers 305 for its metadata. Data and metadata are kept separately in the storage system 300. Metadata, which includes standard file metadata such as file name, creation date, and access control information, also contains the location of the file data on a disk (the extent list). Metadata is kept on high-performance, highly available private server storage (which can be on the same SAN as the data storage or on a separate SAN), and must be accessible by all servers in the cluster. Metadata is never directly accessed by the client computers 301, but is provided to the client computers 301 via the Storage Tank (™) protocol over the control network 206.

Data blocks for any given file are stored on shared devices 303 in one of the storage pools 302. The storage devices 303 must be configured on the storage network 304 to be accessible by both the client computers 301 and the metadata servers 305. In most situations, the storage network 304 would be configured with one zone for the shared storage devices 303, client computers 301 and metadata servers 305. It is also possible, if desired, to create zones accessible by only the metadata servers 305 and a subset of the client computers 301 to meet special security requirements. It is also possible to create a zone accessible only to the metadata servers 305 and metadata store 307 to protect the metadata.

A customer installation can use only one metadata server 305, a cluster 309 of the metadata servers 305, or multiple metadata clusters 309 each comprising the metadata servers 305. Clustered metadata servers 305 provide load balancing, fail-over processing, and increased scalability. The metadata servers 305 in a metadata cluster 309 are interconnected, either on their own high-speed network or on the same IP control network 306 that they use to communicate with the client computers 301. The private server storage that contains the metadata managed by a metadata server cluster 309 can be attached to a private storage network, or to the common storage network 304, perhaps in a separate zone. Storage Tank (™) Protocol

To facilitate the description of the Storage Tank (™) protocol within the distributed storage system 300, the following key terms are defined:

Object: an object is the smallest logical unit for storage and management within a file system residing in the storage system 300. Examples of objects are directories and files. Every Object in the file system is given a unique Object ID.

File: a file is a conventional file system object containing user data.

Directory: a directory is a logical grouping of files as part of the name-space hierarchy. In the storage system 300 of the invention, a directory exists only in the metadata servers 305 and not as an object in user data space in the storage pools 302.

Container: a container is a subtree of the global name-space. It groups a set of objects for the purpose of load balancing and management. The objects in a container can be part of more than one storage pool as defined below.

Volume: a volume is an exported storage device which may be a physical device or a logical device. Volumes are added to storage pools, and must be accessible by all servers and the clients needing access to data on the volume.

Storage pool: a storage pool is a collection of one or more volumes. It provides a logical grouping of the volumes for the allocation of space to the containers. The files in a container can belong to different storage pools. Multiple containers can own storage within a single storage pool.

The invention provides a Storage Tank (™) protocol for the communication between the client computers 301 and the metadata servers 305. This protocol implements a locking and data consistency model that allows the storage system 300 to look and behave like a local file system. The objective of the Storage Tank protocol is to provide strong data consistency between the client computers 301 and metadata servers 305 in a distributed storage environment.

Using the Storage Tank (™) protocol, the client programs in the client computers 301 can determine which storage devices 303 to go to access their data. Each metadata server 305 handles different parts of the name space hierarchy tree (i.e., a different set of containers) and the client programs could determine which metadata server 305 to contact to obtain the required data. Even if the client programs contact a wrong metadata server 305, this server can direct them automatically to the right one. Since the metadata might be distributed over several metadata servers 305, the problem of having too much metadata in one server can be avoided.

The Storage Tank (™) protocol provides data access locks that enable file sharing among the client computers 301, via their client programs, or when necessary, provides locks that allow the client programs to have exclusive access to files. A metadata server 305 grants locks to the client programs when files are opened. The Storage Tank (™) protocol guarantees that when a client computer 301 reads data from a file, it always reads the latest data written to that file by any other client computer.

Storage Clients

The distributed storage system 300 of the invention enables full and transparent data sharing of files among heterogeneous client computers 301, such as those running the Windows 2000, AIX, Solaris, Linux, and HP-UX operating systems. All client programs in the client computers 301 can access the same data using a uniform global name-space. The uniform global name-space provides the ability for all client programs to have a consistent view of the name tree in the storage system 300. This capability requires no changes to existing user applications. The applications only need to use the same interfaces to access data in the storage system 300 as they do to access a native (or local) file system.

The client programs of the client computers 301 direct all metadata operations to one of the metadata server 305, and direct all data operations to the storage devices 303 attached to the high-speed storage network 304. Each client program makes the metadata that is visible to its computer's operating system (and to any applications running on the system) look identical to metadata read from a native, locally attached file system.

FIG. 4 shows the main components of a preferred embodiment for a client program 400 that operates in a client computer 301. The client program 400 runs in the kernel space 411 while user applications 402 run in the user space 401. The kernel space 411 includes, among other subsystems, a memory subsystem 407 and device drivers 406 for a typical client computer. The client program 400 is composed of three components: a file system interface 403, a client state manager (CSM) 404, and operating system (OS) services 405. Porting the client program 400 to a new operating system involves writing the platform-specific file system interface 403 and OS services 405. The client state manager 404, which includes file system-related functions to support the distributed storage system 300, is platform-independent and does not need to be changed. The IFS interface (for Windows-based client computers) or VFS interface (for Unix-based client computers) makes use of the platform's native memory subsystem 407 and device drivers 406.

The client end of the Storage Tank protocol is implemented by the client state manager (CSM) 404. The CSM 404 maintains all locks—both session locks and data locks. The locks are acquired to open files in the storage pools 302. The CSM 404 acts as an intermediary between the platform-specific client file system interface 403 and the metadata servers 305.

The client program 400 in a client computer 301 makes a file system in the storage system 300 appear to be just another file system on the client computer. It has the same semantics as a local file system. A user sees no difference between accessing a file from the storage pools 302 and accessing a file from a local file system. For example, to open a file in a file system residing in the storage system 300, an application issues a standard file open request. The client file system interface 403 passes the request to the CSM 404, which determines whether the request can be satisfied using locks already in its cache. If not, the CSM 404 contacts the metadata servers 305 to obtain the file metadata and locks. The file metadata supplies the client program with information about the file—its attributes and location on storage devices 303. Locks supply the client program with the privileges it needs to open the file and read or write data.

Read and write requests must also be passed to the CSM 404 to ensure that locks are consistent with the access requests. If, for example, the request is a write, but the lock is valid only for reading, the CSM 404 communicates with a metadata server 305 to request that a lock be upgraded. Once the required lock or locks have been obtained, file data can be accessed directly over the storage network 304.

The file access locks in the distributed storage system 300 of the invention might be stored in a cache memory and are preemptible. That is, the file access locks might be taken back by a metadata server 305. This allows the client programs 400 that access the file system to retain distributed locks even when there are no open instances of the file. Thus, requests for a given file by subsequent applications at the same client program 400 may be able to be satisfied without incurring the overhead of contacting the server and obtaining new locks. If a client program 400 requests an incompatible lock for a file for which locks are being cached at another client, the metadata server 305 asks the other client program 400 to release its locks. If there are no open file instances, this client program 400 would comply. Otherwise, the requesting client program 400 is forced to wait.

The CSM 404 also implements the client side of a lease-based protocol that protects the distributed storage system 300 from consistency errors caused by network failures. The metadata servers 305 maintain a lease for each client computer 301 in the system. This lease is opportunistically updated with each client/server interaction. If a metadata server 305 is unable to renew the lease with that client, that client program 400 is assumed to have failed, and the metadata server 305 sets a timer. At the end of this time, the metadata server 305 recovers the locks and is free to provide them to new client programs 400.

From the client side, when the lease expires, a client program 400 must write all dirty data from its cache to disk. Access to the client program's cached data is suspended until the lease is resolved.

The client cache in the client computer 301 is used to achieve low-latency access to metadata and data. A client can cache the following:

Data—Caching data allows a client program 400 to perform reads and writes for files locally, potentially eliminating I/O operations to SAN-attached storage devices 303.

Metadata—Caching metadata allows a client program 400 to perform multiple metadata accesses locally without contacting a metadata server 305. (Note that all metadata updates are sent to the metadata servers 305).

Locks—Caching locks allows a client program 400 to grant multiple opens to a file locally without contacting a metadata server 305.

A client program 400 of the invention performs all caching in memory. If there is not enough space in the client program's cache for all of the data in a file, the client program 400 simply reads the data from the shared storage device 303 on which the file is stored. Data access is fast because the client program 400 has direct access to all storage devices 303 attached to the storage network 304. There is no need for a client program 400 to cache data to a private local disk.

Metadata Servers

In the preferred embodiment of the invention, each metadata server 305 in the storage system 300 is a portable, user-level, C++ application that is easily moved to new operating systems. Ports have been done for Linux, AIX, Sun, and Windows. Support for multiple operating systems provides flexibility in choosing a platform for the metadata server cluster 309. This allows a range of performance options. For example, Intel processors running Linux could be used for cost-effective scalability, while an IBM SP2 supercomputer running AIX could be used for high-end scalability.

Metadata Services

A metadata server 305 is designed to perform metadata updates, serve file system metadata to the client computers 301 (through the client programs 400), grant file and data locks to clients, and detect client failures and perform client recovery. An enterprise can use a single metadata server 305, a cluster 309 of servers, or multiple clusters 309 of servers. Using the metadata servers in a cluster configuration has the following benefits:

Load balancing—The workload and data structures for a file system in the storage system 300 are partitioned and allotted to the metadata servers 305 in the cluster 309. This is a continuous process that keeps the cluster workload balanced at all times. Each metadata server 305 handles a different set of containers. The workloads in the file system might be balanced using various procedures. An example workload balancing process includes the following operations:

(a) keeping track of activity against each container

(b) allocating the busiest container to server 1, the next busiest container to service 2, and so on

(c) the N+1 busiest container is assigned back to server 1, and so on

(d) at every 1 hour interval (for example), reassigning the containers to the metadata servers 305, using new activity information gathered in the last hour.

No data needs to be moved when assignments of containers to metadata servers 305 is changed. All metadata servers 305 have access to all metadata, and they can start processing metadata operations against a different set of containers than before, after a reassignment.

Fail-over processing—A clustering protocol is preferably implemented for the metadata servers 305. In the event of a server failure or loss of network connectivity between metadata servers 305, the cluster services cause a new cluster 309 to be reformed, and the load is distributed among the metadata servers 305 in the new cluster 309.

Scalability—An administrator can add more metadata servers 305 to a cluster 309 or add more server clusters 309 to the storage network 304 to serve more data and more client computers 301. The clustering services described above detect the new metadata server 305, form a new group that includes the new server 305, and redistribute load to balance work across all metadata servers 305 in the new group. Note that multiple metadata server clusters 309 cooperate to maintain the uniform global name-space described above for the storage system 300.

Lock Reassertion

When a metadata server 305 fails, a client computer 301, through the client program 400, can reassert the locks that it holds to a new metadata server 305. Since the client computer 301 can reassert its locks with the new metadata server 305, the file corruption problem caused by a failed server in the prior art storage systems can be avoided.

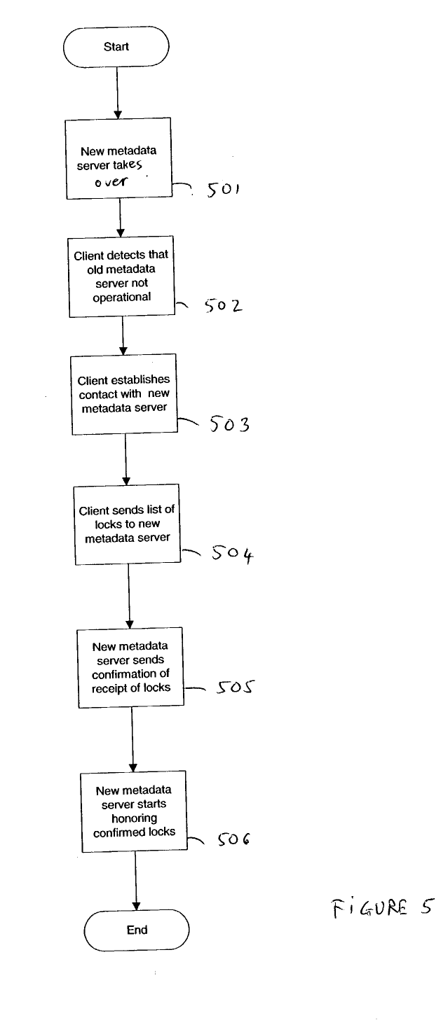

The flowchart of FIG. 5 represents a preferred process for a client program 400 to reassert its access locks to a new metadata server in case of a server failure. At step 501, the new metadata server 305 takes over the responsibilities of a failed metadata server. At step 502, a client program 400 detects that the old metadata server is no longer operational through the control network 306. The client program 400 establishes contact with the new metadata server 305 at step 503. The client program 400 then sends a list of access locks that it currently holds to the new metadata server 305 in step 504. At step 505, the new metadata server 305 sends the client program 400 a confirmation that it has received the list of access locks from the client program 400. The new metadata server 305 then starts to honor the confirmed access locks from the client program 400 at step 506.

One of the problems with current distributed storage systems is the need to move all data from an old file server to a new file server when the customer wants to replace the old file server with one from a different vendor. In the storage system of the invention, because data is separated from metadata, only the metadata needs to be moved from the old metadata server to the new metadata server. The data, which is on the storage pools connected to the storage network 304, does not have to be moved. Since metadata is typically 1% to 10% of the size of the data, the customer could save a lot of time by not having to migrate the data. For example, it is much faster to move only 1 terabyte of metadata than to move 100 terabytes of data.

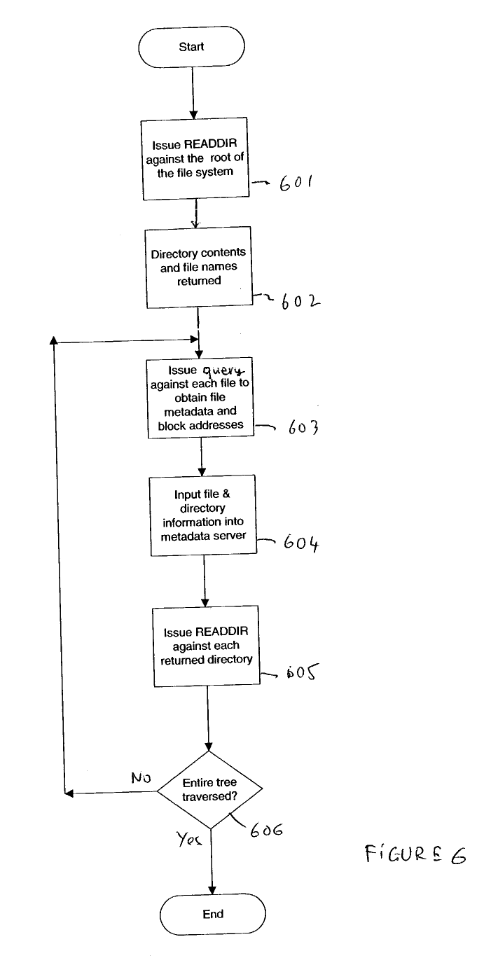

The flowchart of FIG. 6 represents a preferred process for replacing a metadata server 305 in the storage system 300. At step 601, the new metadata server 305 issues a READDIR command against the root of the file system. The contents of root directory, all subdirectories, and lists of file names are returned at step 602. At step 603, the new metadata server 305 issues a query against each of the returned files to get metadata about the file and information on its block addresses. The returned information concerning the directories and files that used to be on the failed metadata server is then input into a new metadata server 305 in step 604. The storage system 300 issues a READDIR command against each of the returned directory or subdirectory at step 605. At step 606, the storage system checks to see whether the entire file hierarchy (file tree) has been traversed. If so, the process for replacing a metadata server 305 is completed as indicated by the “Yes” branch from step 606. Otherwise, the process is repeated from step 602 for all the files in the file system, as indicated by the “No” branch from step 602.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A distributed storage system for sharing data among heterogeneous client computers, comprising:
a plurality of storage pools for storing data accessed by the client computers;
a plurality of metadata servers for providing metadata to the client computers;
a storage network connecting the client computers to the storage pools;
a control network connecting the client computers to the metadata servers, wherein the client computers access data through the storage network and metadata through the control.

2. The system as recited in claim 1, wherein each client computer has a client program for communicating with the storage pools and metadata servers.

3. The system as recited in claim 2, wherein the client program communicates with the metadata servers using a Storage Tank protocol.

4. The system as recited in claim 2, wherein the client program comprises a file system interface for communicating with a file system and user applications, a client state manager for providing data consistency, and a plurality of operating system services for communicating with the metadata servers.

5. The system as recited in claim 4, wherein the client state manager provides data consistency using a plurality of data access locks.

6. The system as recited in claim 5, wherein the data access locks includes session locks and data locks.

7. The system as recited in claim 2, wherein the client program communicates with a Virtual File System (VFS) interface in a Unix-based client computer.

8. The system as recited in claim 2, wherein the client program communicates with an Installable File System (IFS) interface in a Windows-based client computer.

9. In a distributed storage system accessed by multiple heterogeneous client computers, a method for sharing data comprising the steps of:
storing data in a plurality of storage pools, the storage pools being connected to the client computers by a storage network;
storing file metadata in a plurality of metadata servers, the metadata servers being connected to the client computers by a control network; and
providing an operating-system specific client program in each client computer for accessing the metadata servers and storage pools.

10. The method as recited in claim 9, wherein the client program communicates with the metadata servers using a Storage Tank protocol.

11. The method as recited in claim 10, wherein the client program comprises a file system interface for communicating with a file system and user applications, a client state manager for providing data consistency, and a plurality of operating system services for communicating with the metadata servers.

12. The method as recited in claim 11, wherein the client state manager provides data consistency using a plurality of data access locks.

13. The method as recited in claim 12, wherein the data access locks includes session locks and data locks.

14. The method as recited in claim 9, wherein the client program communicates with a Virtual File System (VFS) interface in a Unix-based client computer.

17. The method as recited in claim 9, wherein the client program communicates with an Installable File System (IFS) interface in a Windows-based client computer.

18. A computer-program product for use with a distributed storage system accessed by multiple heterogeneous client computers, the computer-program product comprising:
a computer-readable medium;
means, provided on the computer-readable medium, for storing data in a plurality of storage pools, the storage pools being connected to the client computers by a storage network;
means, provided on the computer-readable medium, for storing file metadata in a plurality of metadata servers, the metadata servers being connected to the client computers by a control network; and
means, provided on the computer-readable medium, for providing an operating-system specific client program in each client computer for accessing the metadata servers and storage pools.

22. The computer-program product as recited in claim 21, wherein the client program communicates with the metadata servers using a Storage Tank protocol.

23. The computer-program product as recited in claim 22, wherein the client program comprises a file system interface for communicating with a file system and user applications, a client state manager for providing data consistency, and a plurality of operating system services for communicating with the metadata servers.

24. The computer-program product as recited in claim 23, wherein the client state manager provides data consistency using a plurality of data access locks.

25. The computer-program product as recited in claim 24, wherein the data access locks includes session locks and data locks.

26. The computer-program product as recited in claim 18, wherein the client program communicates with a Virtual File System (VFS) interface in a Unix-based client computer.

27. The computer-program product as recited in claim 18, wherein the client program communicates with an Installable File System (IFS) interface in a Windows-based client computer.
